(19) United States
(12) Patent Application Publication
(10) Pub. No.: US 2006/0238165 A1
(43) Pub. Date: Oct. 26, 2006

(54) METHOD FOR BATTERY COLD-TEMPERATURE WARM-UP MECHANISM USING CELL EQUILIZATION HARDWARE

(76) Inventors: Stephen W. Moore, Fishers, IN (US); Peter J. Schneider, Carmel, IN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/426,594

(22) Filed: Jun. 27, 2006

Related U.S. Application Data
(63) Continuation of application No. 10/900,650, filed on Jul. 28, 2004, now abandoned.

(51) Int. Cl. H02J 7/00

(52) U.S. Cl. 320/118

(57) ABSTRACT

A method and apparatus for warming up cold temperature lithium chemistry batteries employs a temperature sensor configured to generate a temperature signal indicative of a temperature of the cells of a multi-cell battery. The cells are coupled to a respective balancing circuit having a dissipative resistor that is selectively shunted across the cell for dissipating charge to achieve cell-to-cell balancing. When the temperature is below a temperature threshold, the battery controller engages the balancing resistors to dissipate energy and generate heat to warm up the cells. The cold-temperature shunting is discontinued when a warm-up threshold is reached.

### BACKGROUND OF THE INVENTION

1. Technical Field

This invention relates generally to multi-cell lithium chemistry battery systems, and, more particularly, to a method and apparatus for operating such battery systems.

2. Description of the Related Art

Rechargeable, multi-cell battery systems are known and have been based on various chemistries including lead acid (PbA), nickel cadmium (NiCd), nickel metal hydride (NiMH), lithium ion (LiIon) and lithium polymer (LiPo). A key performance aspect of each battery technology relates to how charging (and overcharging) is accomplished, and how inevitable cell imbalances are addressed.

Conventionally, cell-to-cell imbalances in lead-acid batteries, for example, have been solved by controlled overcharging. Lead-acid batteries can be brought into overcharge conditions without permanent cell damage, inasmuch as the excess energy is released by gassing. This gassing mechanism is the natural method for balancing a series string of lead acid battery cells. Other chemistries, such as NiMH, exhibit similar natural cell-to-cell balancing mechanisms.

Lithium ion and lithium polymer battery chemistries, however, cannot be overcharged without damaging the active materials. The electrolyte breakdown voltage is precariously close to the fully charged terminal voltage. Therefore, careful monitoring and controls must be implemented to avoid any single cell from experiencing an over voltage due to excessive charging. Because a lithium battery cannot be overcharged, there is no natural mechanism for cell equalization.

Even greater challenges exist depending on whether the battery system is a single cell or multiple cells. Single lithium-based cells require monitoring so that cell voltage does not exceed predefined limits of the chemistry. Series-connected lithium cells, however, pose a more complex problem; each cell in the string must be monitored and controlled. Even though the system voltage may appear to be within acceptable limits, one cell of the series string may be experiencing damaging voltage due to cell-to-cell imbalances. Based on the foregoing, without more, the maximum usable capacity of the battery system may not be obtained because during charging, an out-of-balance cell may prematurely approach the end of charge voltage and trigger the charger to turn off (i.e., to save that cell from damage due to overcharge as explained above).

One approach taken in the art to address the foregoing problem involves the concept of cell balancing. Cell balancing is useful to control the higher voltage cells until the rest of the cells can catch up. In this way, the charger is not turned off until the cells reach the end-of-charge (EOC) condition more or less together. More specifically, the cells are first charged, and then, during and at the end-of-charging, the cells are balanced.

One example of a cell balancing approach involves energy dissipation. A shunt resistor, for example, may be selectively engaged in parallel with each cell. This approach shunts the excess energy as each cell reaches an end-of-charge condition, resulting in the system becoming more active as the cells reach full charge. During the moments preceding full charge in a system with n total cells, (n−1) cells are dissipating equalization energy as the last cell approaches end-of-charge. This condition results in a buildup of waste energy in the form of heat, which can trigger thermal controls (i.e., discontinuing the charging temporarily until the temperature comes down). These controls extend the overall charge time for the battery system.

Another problem to be solved is that for lithium chemistry battery types, normal charging currents, when applied at low temperatures, can damage the cells. “Normal” in this regard corresponds to the level of current a lithium battery can accept at standard operating temperature (e.g., 20° C.-68° F.). Low temperature charging can cause lithium metal plating to occur, which consumes and/or damages the internal active elements of the battery.

Methods are known to control battery charging at low temperatures. One such method includes the most obvious, that is, not allowing charging at low temperatures. Another known method includes the use of a separate heating device, such as a heating blanket, to warm the battery to operational temperatures.

Accordingly, there is a need for a method and apparatus for operating a battery system that minimizes or eliminates one or more of the problems as set forth above.

### SUMMARY OF THE INVENTION

One advantage of the present invention is that it allows for the low temperature charging of a lithium battery system without the need for a separate heating element.

These and other features, advantages, and objects are achieved by a method of operating a battery system in accordance with the present invention.

In a first aspect of the invention, a lithium battery system is provided. The battery system has a plurality of cells, a dissipative balancing circuit, a temperature sensor, and a battery controller. The balancing circuit is associated with at least one of the plurality of cells and is operable to dissipate charge of the at least one cell (e.g., in the form of heat). In a preferred embodiment, the balancing circuit includes a resistor. The temperature sensor is configured to generate a temperature signal indicative of the temperature of the at least one cell. The battery controller is configured to engage the balancing circuit when the temperature is below a first predetermined level. Turning on the balancing circuit is operative to produce heat which can be used to warm the cell(s), raising the temperature to a level suitable for charging, for example.

In one embodiment, the system includes a balancing circuit for each cell, wherein the controller is configured to engage one or more of such balancing circuits. The controller is configured to discontinue engagement of the balancing circuit(s) when the temperature reaches a second predetermined level, a level suitable for charging operations.

### BRIEF DESCRIPTION OF THE DRAWINGS

The present invention will now be described by way of example, with reference to the accompanying drawings.

FIG. 1 is a schematic and block diagram view of a multi-cell battery system according to the present invention.

FIG. 2 is a state of charge (SOC) versus temperature graph showing various operating regions of the present invention.

FIG. 3 is a flowchart showing a process for cold temperature warm-up according to the present invention.

### DETAILED DESCRIPTION OF THE PREFERRED EMBODIMENT

Multi-cell lithium battery systems do not have a natural cell-balancing or equilization technique, as described in the Background. Therefore, such cell-balancing circuitry is often employed to provide active cell balancing. Such circuitry often includes dissipative devices (e.g., in the form of an electrical resistor) to dissipate charge from selected battery cells, therefore causing the selected cells to match the capacity of the other cells in the system.

The present invention configures a lithium battery controller to use the dissipative balancing circuit(s) to produce heat to warm the cells of the system when cold temperature conditions prevail.

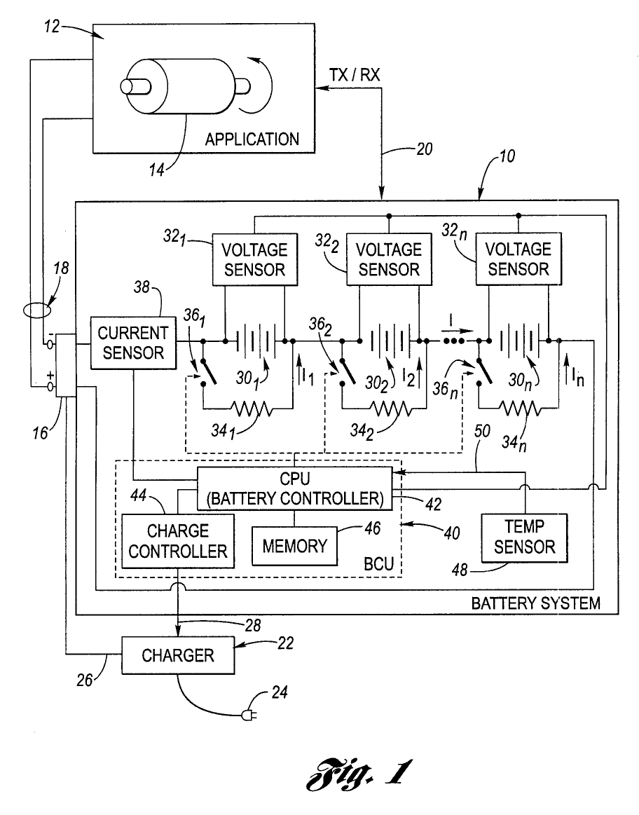

Referring now to the drawings wherein like reference numerals are used to identify identical components in the various views, FIG. 1 is a simplified, schematic and block diagram view of an inventive battery system 10 according to the invention suitable for use in connection with any one or more of a plurality of exemplary host applications 12. Application 12 may be of the type that employs a dynamoelectric machine 14, which can alternatively be configured for operation (i) in a first mode wherein the machine 14 is used for propulsion torque, or (ii) in a second mode different from the first mode wherein the machine 14 is configured for the production of regenerative energy (i.e., it is configured as a generator). For example, such applications may include, but are not limited to, self-propelled vehicle applications, although other application stationary in nature (i.e., rotating systems having loads with inertia) are also included within the spirit and scope of the invention. Dynamoelectric machine 14 may comprise conventional apparatus known to those in the art, for example only, AC or DC electric motors, brush-based or brushless electric motors, electromagnet or permanent magnetic based electric motors, reluctance-based electric motors, or the like. It should be clearly understood that the foregoing is exemplary only and not limiting in nature. Other host applications 12 may include more static situations that nonetheless may benefit from a rechargeable battery system 10 in accordance with the present invention.

With continued reference to FIG. 1, battery system 10 may include an input/output terminal 16. A power bus 18 is configured to allow electrical power to be drawn from battery system 10 when application 12 so requires. If the application 14 is so arranged, power bus 18 may alternatively be configured or used to carry electric energy, herein referred to as regenerative energy, produced by dynamoelectric machine 14 when it is operated in a regenerative energy production mode (as a generator). As further shown, in the illustrated embodiment, battery system 10 may also include a communications port configured for connection to a communications line 20, designated “TX/RX” (transmit/receive) in FIG. 1. Communications line 20 may be configured for bi-directional communications, for example, transmission of control signals or control messages, between battery system 10 and host application 12, should application 12 be so configured.

FIG. 1 also shows an electrical battery charger 22, including in exemplary fashion a conventional electrical plug 24 for connection to a wall outlet (not shown) or the like. Charger 22 is configured for charging (or recharging) battery system 10. Charger 22 includes a charging power line 26 configured for connection to battery system 10 for charging (or recharging) the battery cells thereof, although for simplicity sake, line 26 is shown connected to the terminal 16. In addition, charger 22 may have an input configured to receive a control signal, such as a charge termination signal, on a control line 28 from battery system 10. The charge termination signal on line 28 is configured to cause charger 22 to discontinue charging battery system 10 (i.e., to stop charging), for example, when the battery system 10 has been charged. Alternatively, charger 22 may be variable charger 22 wherein the control signal on line 28 is operative to adjust the charging current as well as to terminate the charge current. Charger 22 may comprise conventional charging componentry known to those of ordinary skill in the art.

In the illustrated embodiment, battery system 10 includes one or more battery cells 30₁, 30₂, . . . 30ₙ, at least one voltage sensor 32, but preferably a plurality of voltage sensors 32₁, 32₂, . . . 32ₙ, a dissipative balancing circuit comprising a plurality of balancing resistors 34₁, 34₂, . . . 34ₙ, and a corresponding plurality of controlled switches 36₁, 36₂, . . . 36ₙ, at least one current sensor 38 and a battery control unit (BCU) 40. BCU 40 may include a battery controller such as a central processing unit (CPU) 42, a charge controller 44, and a memory 46.

Cells 30₁, 30₂, . . . 30ₙ are configured to produce electrical power, and may be arranged so that the collective output thereof, designated as current I, is provided on I/O terminal 16, as in the illustrated embodiment. Conventional electrical current flows out of terminal 16 to the load (i.e., the application 12). Cells 30₁, 30₂, . . . 30ₙ are also configured to be rechargeable, for example, by receiving conventional electrical current into battery system 10 at I/O terminal 16. The recharging current may be from either charger 22 or from machine 14 operating as a generator. Cells 30₁, 30₂, . . . 30ₙ may comprise conventional apparatus according to known battery technologies, such as those described in the Background, for example, various Lithium chemistries known to those of ordinary skill in the energy storage art. In the illustrated embodiment, cells 30₁, 30₂, . . . 30ₙ are arranged to produce collectively a direct current (DC) output at a predetermined, nominal level (e.g., in one embodiment, nominally 4 volts for each cell).

The plurality of voltage sensors 32₁, 32₂, . . . 32ₙ are configured to detect a respective voltage level for each cell and produce a corresponding voltage indicative signal representative of the detected voltage. In one embodiment a plurality of voltage sensors 32 are employed, at least one for each individual cell included in battery system 10. In an alternate embodiment, one voltage sensor may be provided in combination with a multiplexing scheme configured to sample the voltage at each cell at predetermined times. This has the same effect as providing multiple sensors 32. Through the foregoing multiple sensor approach, advanced diagnostics and charging strategies may be implemented, as understood by those of ordinary skill in the art, and as will be described in greater detail below. Voltage sensor(s) 32₁, 32₂, . . . 32ₙ may comprise conventional apparatus known in the art.

Battery system 10 includes apparatus and functionality to implement cell-to-cell charge balancing. In the illustrated embodiment, an energy dissipative balancing circuit(s) is shown, and includes a plurality of balancing resistors 34₁, 34₂, . . . 34ₙ and a corresponding plurality of switches 36₁, 36₂, . . . 36ₙ to selectively engage such resistors, all on a per cell basis via battery controller 42. The energy dissipative balancing approach selectively shunts selected cells with selected value resistors to remove charge from the highest charged cells until they are near or match the charge on the lowest charged cells. In one embodiment, a 40 W balancing resistor is used, which, assuming a nominal cell voltage of about 3.65 V, could achieve a dissipation_rate (expressed in amperes) of about 0.09125 A (about 90 mA).

Current sensor 38 is configured to detect a current level and polarity of the electrical (conventional) current flowing out of (or into) battery system 10 via terminal 16, and generate in response a current indicative signal representative of both level and polarity. Current sensor 38 may comprise conventional apparatus known in the art.

Battery Control Unit (BCU) 40 is configured for controlling the overall operation of battery system 10, including control of the charging and balancing strategies according to the invention. BCU 40 may include a battery controller such as a central processing unit (CPU) 42, a charge controller 44, and a memory 46.

Battery controller 42 may comprise conventional processing apparatus known in the art, capable of executing preprogrammed instructions stored in memory 46, all in accordance with the functionality described in this document. That is, it is contemplated that the processes described in this application will be programmed, with the resulting software code being stored in memory 46 for execution by battery controller 42. Implementation of the present inventive method logic, in software, in view of this enabling document, would require no more than routine application of programming skills. Memory 46 is coupled to battery controller 42, and may comprise conventional memory devices, for example, a suitable combination of volatile, and non-volatile memory so that main line software can be stored and yet allow storage and processing of dynamically produced data and/or signals. It should be understood, however, that the present invention may be implemented using a purely hardware approach (as opposed to a programmed digital implementation). A hardware implementation is within the spirit and scope of the present invention.

Charge controller 44 is also coupled to CPU 42, and is configured so as to allow battery controller 42 to preset a charge termination voltage, such that when the actual voltage level(s) from sensor(s) 32₁, 32₂, . . . 32ₙ reach a respective charge termination voltage, charge controller 44 may generate the above-mentioned charge termination signal on line 28 and/or alternately engage a balancing resistor(s) to shunt/dissipate energy for a particular cell(s). This control signal may be operative to shut down external charger 22, as described above. Charge controller 44 may be configured as a separate unit or circuit, as illustrated, or may be implemented in software executed on battery controller 42.

FIG. 1 further illustrates a temperature sensor 48 configured to generate a temperature signal 50 indicative of a temperature of one or more of the cells 30₁, 30₂, . . . 30ₙ. The temperature sensor may comprise conventional components known to those of ordinary skill in the art.

While in FIG. 1 all of the structures are shown as included in battery system 10, it should be understood that battery system 10 is configured to provide a predetermined degree of thermal coupling between the array of balancing resistors (i.e., that which produces the heat when engaged by battery controller 42) and the plurality of cells themselves (i.e., that which receives the heat so produced).

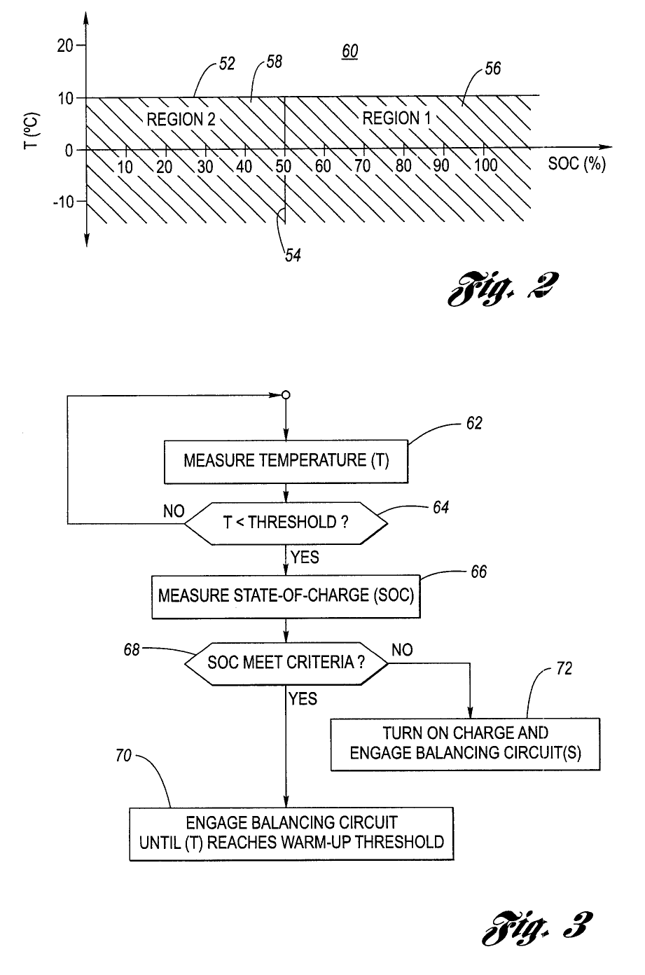

FIG. 2 is a state of charge (SOC) versus temperature chart used to illustrate the operation of the present invention. As described in the Background, charging the cells when the temperature is below normal operating temperatures can damage the cells. The present invention provides a mechanism to heat the cells to a temperature where charging can occur safely without the need for a separate warming structure, such as a heating blanket. FIG. 2 shows a first predetermined temperature level 52, a first predetermined state of charge (SOC) level 54, a first operating region 56 (“REGION 1”), a second operating region (“REGION 2”) and a third region 60.

It should be understood that the SOC determination itself, per se, is outside the present invention. That is, the present invention is not limited to any particular method be it simple or complex for determining the SOC of the cell. More generally, the functionality included in the present invention determines principally whether the cell(s) have enough energy to power the dissipation resistor(s) to produce the heat referred to above to warm the cells. In this regard, it is contemplated that a simple voltage measurement/assessment would be sufficient to implement the present invention, and is specifically contemplated that such voltage measurement would fall within the spirit and scope of the present invention. Hereinafter, it should be understood that references to SOC should be interpreted broadly to cover such variations.

In general, when the temperature is below the first predetermined temperature threshold 52, and the battery cell's state of charge (SOC) is sufficiently high at the beginning of charge (e.g., greater than SOC level 54), then the battery controller 42, as configured in accordance with the present invention, is operative to engage the dissipative balancing devices (e.g., resistors) associated with one or more of the cells, thus creating heat. When the battery cells receives sufficient heat and the temperature of the cells of the battery increase to a second predetermined temperature level indicative of operational levels (e.g., equal to the first temperature level 52), operation is in the third region 60 and the battery controller 42 can revert to conventional charging strategies (e.g., discontinue engagement of the balancing resistors and activate or otherwise fully engage the charger).

In an alternate embodiment, when the temperature is below the first temperature level 52 and there is not enough charge in the battery (e.g., the SOC is less than SOC level 54) to facilitate the warm up period, operation is in REGION 2 and the charger can be engaged for a short time to provide the energy. In this regard, the dissipative balancing devices (e.g., resistors) could then be engaged during this time, creating the heat. For operation in REGION 2, the battery controller 42 is configured so that the charger is operated at some frequency, e.g., in bursts, to supply the system with energy for heating purposes. Such operation continues until the battery system 10, specifically the cells thereof, are sufficiently warmed up (e.g., equal to temperature level 52), at which time the battery controller 42 can revert to conventional charging strategies (e.g., discontinue engagement of the balancing resistors and activate or otherwise fully engage the charger). This mode of operation is best shown as block 72 in FIG. 3, which will be described below as part of an overall method.

Additionally, if only some of the cells have enough initial charge, the dissipative balancing devices for those cells may be engaged by battery controller 42, thus sparing the lower-charged cells from having their charge dissipated to create heat. In this still further embodiment, a decreased amount of heat is produced, but has the advantage of avoiding a deep discharge of the lowest charged cells in the system.

FIG. 3 is a flowchart showing a process for warming up a lithium chemistry battery system in accordance with the present invention. The method begins in step 62, wherein the temperature sensor 48 generates a temperature signal 50 indicative of a temperature of at least one of the cells 30. In alternate embodiments, the temperature signal 50 may be indicative of the average temperature of all the cells. Temperature signal 50 is then provided to battery controller 42 for further evaluation, as described below. The method then proceeds to step 64.

In step 64, battery controller 42 is configured to determine whether the temperature, as represented by temperature signal 50, is below a first predetermined temperature level or threshold. While “normal” operating temperatures may be assumed to be about 20° C. (68° F.), a “cold” temperature may be any temperature below 0° C. or below a temperature at which lithium plating is proven to occur during charging at a predetermined current. That is, the phenomena of lithium plating occurs as a function of both temperature and current (i.e., charging current level). For example, for a small, “trickle” current, the temperature may go to as low as −10° C. before plating occurs whereas for a normal charging current, the temperature at which plating occurs may be nearer to 0° C.

If the answer to decision block 64 is NO, then the method loops onto itself (i.e., battery controller 42 will continue to operate as per its normal configuration). If the answer to decision block 64 is YES, however, then the method branches to step 66.

In step 66, battery controller 42 determines the state of charge (SOC) for each of the cells 30₁, 30₂, . . . 30ₙ included within the battery system 10. The standard configuration of battery system 10, and battery controller 42 in particular, may be configured with conventional SOC determination algorithms, and hence will not be discussed in any further detail herein. The method then continues to decision block 68.

In decision block 68, battery controller 42 is configured to determine whether predetermined SOC criteria have been met. In one embodiment, the predetermined SOC criteria is a simple SOC level above which all the SOC levels of the individual cells must exceed. In an alternate embodiment, the SOC criteria would be satisfied if any of the cells meet the simple SOC level mentioned above. If the answer to the decision block 68 is YES, then the method branches to step 70.

It should be understood, based on the foregoing paragraphs, that steps 66 and 68 are not limited to SOC per se, but in effect also cover the voltage of the cell(s) or other operating characteristics that are indicative of whether the cells have enough energy to power the dissipation resistor(s).

In step 70, the battery controller 42 is configured to engage one or more balancing circuits until the temperature signal 50 indicates that the temperature has reached a warm up temperature level (i.e., a second predetermined temperature level). In one embodiment where all the respective SOC of all the cells exceed the simple SOC level mentioned above, then the battery controller 42 is configured to engage the balancing circuits (resistors) associated with all these cells through selective closure of the corresponding switches 36 (best shown in FIG. 1). In the alternate embodiment where less than all of the cells satisfy the minimum SOC level described above, then battery controller 42 is configured to engage just those balancing circuits (resistors) associated with only those cells satisfying the predetermined minimum SOC level, through selective closure of the corresponding switches 36. The balancing circuits remain engaged until the temperature comes up to the warm up temperature level. While in one embodiment, the warm up temperature level is the same level that triggers the invention in the first place, in a preferred embodiment, a small amount of hysteresis is employed such that the warm up temperature level (i.e., second predetermined temperature level) is slightly higher than the first predetermined level (i.e., trigger).

If, however, the answer to decision block 68 is NO, then the method branches to step 72.

In step 72, in a still further embodiment, the battery controller 42 is configured to (i) engage one or more balancing circuits (resistors) in combination with (ii) engaging the charger for a short time to provide the energy to produce the heat. The battery controller 42 is configured to engage the charger at some predetermined frequency, e.g., in bursts, to supply the system with energy for heating purposes. Such operation continues until the battery system, particularly the cells thereof, have sufficiently warmed (i.e., reached the warm up temperature level, as described above), at which time the charger is fully engaged, per conventional charging strategies, as described above.

It should be understood that the foregoing is exemplary rather than limiting in nature. Alternatives and variations are possible and yet remain within the spirit and scope of the present invention.

1-14. (canceled)

15. A method for charging a lithium battery system having a plurality of cells and an energy dissipative balancing circuit associated with the cells, comprising:
sensing a temperature of the battery;
sensing a state of charge of the battery; and,
if the temperature of the battery is below a predetermined temperature and if the state of charge meets predetermined criteria, coupling the energy dissipative balancing circuit with at least one of the cells to transfer electrical energy from the at least one of the cells to the energy dissipative balancing circuit to heat the battery.

16. A method, as set forth in claim 15, wherein the battery is not charged while the temperature of the battery is below the predetermined temperature.

17. A method, as set forth in claim 15, wherein the battery is not charged if the temperature of the battery is below the predetermined temperature and the state of charge associated with one of the cells meets the predetermined criteria.

18. A method, as set forth in claim 14, including the step of, if the temperature of the battery is below a predetermined temperature and if the state of charge does not meet the predetermined criteria, coupling the energy dissipative balancing circuit with at least one of the cells to transfer electrical energy from the at least one of the cells to the energy dissipative balancing circuit while charging the battery for a short time to provide the energy to create heat.

19. A method, as set forth in claim 18, wherein the step of charging the battery for a short time includes the step of charging the battery in bursts.

20. A method, as set forth in claim 18, wherein the step of charging the battery for a short time includes the step of charging the battery at a predetermined frequency.

21. A method, as set forth in claim 14, wherein the step of sensing a state of charge of the battery includes the step of sensing a state of charge of each of the cells of the battery, wherein only the cells whose state of charge meets the predetermined criteria are coupled to the energy dissipative balancing circuit.

22. A lithium battery system comprising:
a battery;
an energy dissipative balancing circuit associated with the battery for selectively dissipating electrical energy thereof;
a switch for selectively coupling the energy dissipating balancing circuit to the battery to transfer electrical energy to the energy dissipating balancing circuit;
a temperature sensor configured to generate a temperature signal indicative of a temperature associated with the battery;
a SOC sensor coupled to the battery for detecting a state of charge of the battery; and
a battery controller coupled to the switch, the temperature sensor, and the SOC sensor for coupling the energy dissipative balancing circuit with the battery via the switch to transfer electrical energy from the battery to the energy dissipative balancing circuit to heat the battery, if the temperature signal is below a predetermined temperature and if the state of charge meets predetermined criteria.

23. A system, as set forth in claim 22, wherein the battery is not charged while the temperature of the battery is below the predetermined temperature.

24. A system, as set forth in claim 22, wherein the battery is not charged if the temperature of the battery is below the predetermined temperature and the state of charge associated with one of the cells meets the predetermined criteria.

25. A system, as set forth in claim 22, the controller for coupling the energy dissipative balancing circuit with the battery to transfer electrical energy from the at least one of the cells to the energy dissipative balancing circuit while charging the battery for a short time to provide energy to create heat, if the temperature signal of the battery is below a predetermined temperature and if the state of charge does not meet the predetermined criteria.

26. A system, as set forth in claim 25, wherein the controller in charging the battery for a short time to provide the energy, charges the battery in bursts.

27. A system, as set forth in claim 25, wherein the controller in charging the battery for a short time, charges the battery at a predetermined frequency.

28. A system, as set forth in claim 22, wherein the battery controller is further configured to control charging the battery in accordance with a charging strategy when the temperature reaches a second predetermined level.

29. A system, as set forth in claim 22, wherein the battery controller is further configured to discontinue engagement of the balancing circuit and commence charging of the battery when said temperature reaches a second predetermined level.

30. A system, as set forth in claim 22, wherein the SOC sensor includes a voltage sensor.

31. A system, as set forth in claim 22, wherein the energy dissipative balancing circuit includes a resistor.

32. A lithium battery system comprising:
a battery having a plurality of cells;
an energy dissipative balancing circuit associated with the cells of the battery for selectively dissipating electrical energy of each cell;
a plurality of switches for selectively coupling the energy dissipating balancing circuit to each cell to transfer electrical energy to the energy dissipating balancing circuit;
a temperature sensor configured to generate a temperature signal indicative of a temperature associated with the battery;
a SOC sensor coupled to each cell of the battery for detecting a state of charge of each cell of the battery; and
a battery controller coupled to the switches, the temperature sensor, and the SOC sensor for coupling the energy dissipative balancing circuit with at least one of the cells of the battery via the switches to transfer electrical energy from the at least one of the cells to the energy dissipative balancing circuit to heat the battery, if the temperature signal of the battery is below a predetermined temperature and if the state of charge of the at least one of the cells meets predetermined criteria.

33. A system, as set forth in claim 32, wherein the battery is not charged while the temperature of the battery is below the predetermined temperature.

34. A system, as set forth in claim 32, wherein the battery is not charged if the temperature of the battery is below the predetermined temperature and the state of charge associated with one of the cells meets the predetermined criteria.

35. A system, as set forth in claim 32, the controller for coupling the energy dissipative balancing circuit with the at least one of the cells of the battery to transfer electrical energy from the at least one of the cells to the energy dissipative balancing circuit while charging the battery for a short time to provide the energy to create heat, if the temperature signal is below a predetermined temperature and if the state of charge of the at least one of the cells of the battery does not meet the predetermined criteria.

36. A system, as set forth in claim 35, wherein the controller in charging the battery for a short time, charges the battery in bursts.

37. A system, as set forth in claim 35, wherein the controller in charging the battery for a short time, charges the battery at a predetermined frequency.

38. A system, as set forth in claim 32, wherein the battery controller is further configured to control charging of said plurality of cells in accordance with a charging strategy when the temperature signal reaches a second predetermined level.

38. A system, as set forth in claim 32, wherein the battery controller is further configured to discontinue engagement of said balancing circuit and commence charging of the cells when the temperature signal reaches a second predetermined level.

39. A system, as set forth in claim 32, wherein the SOC sensor includes a voltage sensor.

40. A system, as set forth in claim 32, wherein the energy dissipative balancing circuit includes a resistor.
